(19) United States
(12) Patent Application Publication
(10) Pub. No.: US 2021/0327196 A1
(43) Pub. Date: Oct. 21, 2021

(54) CURRENCY NOTE ACCEPTOR

(71) Applicant: Microsystem Controls Pty Ltd, Port Melbourne (AU)

(72) Inventor: Robert Kingsley Bird, Port Melbourne (AU)

(21) Appl. No.: 17/233,751

(22) Filed: Apr. 19, 2021

(30) Foreign Application Priority Data
Apr. 20, 2020 (AU) 2020901245

(51) Int. Cl. G07D 11/22; G07D 11/40; G07D 11/13; G07D 7/00

(52) U.S. Cl. CPC G07D 11/22; G07D 7/00; G07D 11/13; G07D 11/40

(57) ABSTRACT

A currency note acceptor for accepting currency notes, including: a housing defining a pathway for passage of an inserted currency note from an opening to a storage compartment; a currency note validator for examining and validating currency notes along the pathway; an obstruction operatively associated with the currency note validator, the obstruction being changeable between a first operative state to obstruct entry in and/or out of the storage compartment and a second operative state to allow passage of the currency note along the pathway into the storage compartment; wherein the acceptor is operable to: receive a currency note during a receiving phase; change the obstruction during an accepting phase such that it is in the second operative state following validation of the currency note to allow stowage of the note in the storage compartment; and subsequently change the obstruction such that it is in the first operative state during a subsequent receiving phase for a subsequent currency note.

### FIELD OF THE INVENTION

This invention relates generally to the identification and validation of currency notes and more particularly to prevent use of retrieving strings or the like, for the purpose of fraudulently retrieving a note already inserted and validated. Although the invention is of wide application, it is especially applicable to the identification and validation of paper currency in change dispensers, pay stations, vending machines, electronic gaming machines and other equipment where payment is made or an operation enabled by insertion of a currency note. Currency notes are also known as banknotes, paper money or bills.

### BACKGROUND OF THE INVENTION

The use of currency note validators for the purpose of authenticating currency and providing goods, services or change in return, is well known. Many of these validators include a slot opening for receiving currency notes. The note moves along a note path to be tested for authenticity. It is held in escrow while being tested for authenticity. If the note testing determines an invalid note, the note is returned by the reversal of the drive moving the note along the path. If the currency note validator recognises the inserted item as a valid denomination currency note, its controller will issue an enabling credit signal to associated equipment such as the vending machine or the gaming machine. The note is then moved further by the drive along the note path out of escrow and to a storage location typically provided in a note stacker module.

A fraudulent activity known as ‘stringing’ is to retrieve a currency note by attaching a piece of string or tape to the note and pulling the note out, once it has been validated and credit has been given. To assist in pulling the strung note out, an invalid piece of paper may be inserted, with the rejection of the paper reversing the rollers, which makes it easier to pull out the strung note. There have been a number of attempts to counteract such “stringing” activity.

U.S. Pat. No. 8,499,917 discloses a foreign object detector which has a gate in the note path after the insertion slot and before escrow. The gate is biased towards the fully closed position and is openable to allow the note to pass the gate. In the fully closed position, a leading edge of the gate intersects the note path and is received within a recess thereby obstructing passage of foreign objects such as string or tape into the currency note validator. A foreign object lying in the note path such as string or tape will obstruct the recess and prevent the gate from reaching the fully closed position, in which case the sensing means thereby detects the presence of the foreign object in the note path.

As a variation of ‘stringing’, ‘fishing’ is another fraudulent activity or a variation of ‘stringing’. With ‘fishing’, the fraudster attaches a long strip of mylar to a note and folds it up on the note. This mylar strip has a loop on it. The note is inserted and typically, the note is validated and accepted and a credit is given to the machine. A second note is then inserted with a modification that enables it to keep the gate open deliberately. While the second note is holding the gate open, a strong mylar strip is then inserted into the note acceptor and the looped note is “hooked” and pulled out and the second note is also retrieved. The fraudster then redeems the credit from the machine operator. In the case of an electronic gaming machine, this may be the casino operator who pays the value of the retrieved currency note to the fraudster.

It is desirable to provide a currency note acceptor that can reduce or eliminate the problems associated with ‘stringing’ and ‘fishing’. Alternatively, it is desirable to provide a currency note acceptor that provides a useful alternative to that which is known in the prior art.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a currency note acceptor for accepting currency notes, including:

a housing defining a pathway for passage of an inserted currency note from an opening to a storage compartment;

a currency note validator for examining and validating currency notes along the pathway;

an obstruction operatively associated with the currency note validator, the obstruction being changeable between a first operative state to obstruct entry in and/or out of the storage compartment and a second operative state to allow passage of the currency note along the pathway into the storage compartment;

wherein the acceptor is operable to:

receive a currency note during a receiving phase;

change the obstruction during an accepting phase such that it is in the second operative state following validation of the currency note to allow stowage of the note in the storage compartment; and

subsequently change the obstruction such that it is in the first operative state during a subsequent receiving phase for a subsequent currency note.

Following stowage of the note, the obstruction may remain in the first operative state until validation of a subsequently inserted currency note. Preferably, the acceptor is operable to retain the obstruction in the first operative state for substantially the duration of operation, with only a temporary change to the second operative state, post-validation. However, it is possible that the obstruction may remain in the first operative state for a shorter period. For example, the currency note acceptor or the machine in which it is installed may include a sensor to detect the presence of a person near the machine, with the obstruction changing to the first operative state in response to detection of a nearby person and otherwise being in the second operative state.

Advantageously, the present invention can reduce or eliminate the issues associated with a consumer fraudulently attempting to retrieve the currency note, i.e. ‘fishing’ the currency note, from the currency note acceptor after the currency note has been validated and the consumer credited. When the obstruction is in the first operative state, attempts by the consumer to direct an object, such as a string or other long strip of material, into the currency note acceptor and into the storage compartment will be obstructed. Such obstruction reduces or eliminates completely the likelihood of a consumer being able to ‘fish’ the currency note out of the currency note acceptor.

In an embodiment, the currency note acceptor includes a note receiver, the storage compartment being disposed in the note receiver. The note receiver may form part of the housing of the acceptor. Alternatively, the note receiver may comprise a module or cassette which is detachable from the housing.

The pathway for the currency note may include passage from the opening, through the currency note validator, through escrow, to an entry to the storage compartment and ultimately into the storage compartment, the terminus of the note pathway. A portion of the pathway, preferably the terminus may thus be disposed in the note receiver. The entry to the storage compartment may be a holding compartment, immediately prior to the storage compartment.

In an embodiment, one or more components of an obstruction assembly which change the obstruction are disposed in the note receiving module. The storage compartment may comprise a stacking-type compartment in which the notes are stacked. Thus, the note receiving module may be in the form of a stacker module which stacks the notes.

In an embodiment, between the entry of the storage compartment and the storage compartment itself is provided a storage entry aperture which provides access for the note into the storage compartment. Typically, in such forms of the invention, the note is punched by a punch plate from the holding compartment. In some embodiments, the note is punched from the holding compartment by the punch plate on more than one occasion, e.g. two times. This enhances the likelihood that the note is properly received in the storage compartment.

In some embodiments, an upstand extends from at least a portion of the periphery of the storage entry aperture towards the storage compartment. The upstand may include an abutment surface configured to abut against a most recently received currency note.

Preferably, there is also provided a holding compartment aperture. Typically, in this form, the obstruction or one or more components of the obstruction assembly blocks the holding compartment aperture in the first operative state.

Thus, the obstruction may be disposed at or within the storage entry aperture. Alternatively or additionally, the obstruction may be disposed to obstruct the holding compartment aperture.

The obstruction may comprise any number of suitable forms which either allow passage along the pathway into the storage compartment or obstruct such passage, thereby also obstructing withdrawal from the storage compartment. The changeable obstruction may comprise a movable obstruction. For example, a mechanical gate may serve as the movable obstruction. Typically, movable obstructions will have an associated driver and are driven between the first and second operative states. Alternatively, the changeable obstruction could be in the form of two adjacent pneumatic bladders which are inflated to obstruct passage. In a preferred form of the invention, the obstruction takes the form of a punch or push plate assembly which has the dual function of punching or pushing the note from the holding compartment into the storage compartment.

In an embodiment, the obstruction functions/adopts in the first operative state upon receiving a first indication that a currency note has been urged through the entry aperture into the storage compartment, and the obstruction functions/adopts in the second operative state upon receiving a second indication that a currency note has been validated.

Advantageously, after the currency note has been validated, the obstruction is changed to the second operative state to provide a clear path for the currency note to traverse the pathway towards and into the note receiver.

In a more preferred embodiment, the change of the obstruction to the second operative state may be temporary. After the currency note has been received in the storage compartment, the obstruction will then function in the first operative state, thereby obstructing entry into the storage compartment to obstruct ‘fishing’ of the stored currency note. In one preferred form of this embodiment employing a punch plate assembly which serves as the obstruction, the punch plate may punch the note through an entry aperture from the holding compartment to the storage compartment, thereby adopting the first operative state and may thereafter remain in the first operative state until a subsequent note is validated. However, in a most preferred form of this embodiment, the punch plate may punch the note through to adopt the first operative state, may temporarily return to the second operative state and then return to the first operative state.

In such preferred forms, the first operative state may include a number of positions of the punch plate. For example, the extent of the punch plate into the storage compartment may be one such obstructed position. Additionally, the punch plate may reside within the entry aperture, with the punch plate assembly serving to obstruct entry into the storage compartment.

In the most preferred form of this embodiment, the punch plate remains flush with the entry aperture until a subsequent note is validated, triggering a change of the obstruction to the second operative state.

In an embodiment, the obstruction assembly further includes a movable scissor arm mechanism associated with the punch plate, the scissor arm mechanism including one or more scissor arm members, wherein when the obstruction assembly is in the first operative state, the one or more scissor arm members obstruct the pathway. In particular, in the embodiment with a holding compartment the one or more scissor arm members obstruct the holding compartment aperture and thus block access to the holding compartment.

Thus, the one or more scissor arm members act to obstruct the progress of an unauthorised object that enters the currency note acceptor. For example, string or any other elongate object may be hindered or become entangled with the scissor arm members, thereby preventing the object from reaching the validated currency note in the storage compartment.

It is preferable that the punch plate is of similar dimension, both in length and width, to the entry aperture in order to substantially block or close the entry aperture, thereby preventing fraudulent access into the storage compartment. Thus, any foreign object that enters the currency note acceptor is prevented from reaching a validated currency note stored in the storage compartment.

In an embodiment, the currency note acceptor includes a controller associated with the currency note validator and the obstruction/obstruction assembly. The controller is suitably configured to send the first and second indications to the obstruction/obstruction assembly, thereby controlling in which operative state the obstruction/obstruction assembly is to function. The controller may also receive feedback from various sensors along the pathway, detecting the position of the currency note.

Preferably, the controller will receive a signal from the currency note validator as to whether a currency note has been validated. If the currency note has been validated, the controller will send the second indication to the obstruction/obstruction assembly. Once the controller has received a further signal from the obstruction/obstruction assembly that the currency note has entered the entry to the storage compartment, the controller will send the first indication to the obstruction/obstruction assembly, causing the obstruction/obstruction assembly to operate in the first operative state in which entry into the storage compartment and/or the storage compartment itself is obstructed. Alternatively, the controller may also control the operation of the punch plate. Thus, upon punching a note through to the storage compartment, the controller may retain the punch plate in the first operative state, either in an extended punch position, a home position within the entry aperture or another position blocking or obstructing passage into the storage compartment.

The opening of the housing may be in the form of an entry slot in an external wall of the housing communicable with the pathway, the entry slot being configured to allow a currency note to be inserted into the housing. Further, a conveyor assembly may be configured to move the currency note along the pathway, from the opening towards the storage compartment.

In a second aspect, the present invention provides a method for storing currency notes in a currency note acceptor which includes a pathway for passage of the currency note from an opening to a storage compartment and a currency note validator for examining and validating currency notes along the pathway, the method including:

receiving a currency note through the opening during a receiving phase;

allowing the inserted currency note which has been validated by the currency note validator to pass along the pathway to the storage compartment during an accepting phase; and

obstructing passage in and/or out of the storage compartment during a subsequent receiving phase for a subsequent currency note.

Any of the features described above in connection with the other aspects of the invention set out herein may be applicable to the second aspect of the invention.

In a third aspect, the present invention provides a method for configuring a currency note acceptor which includes a pathway for passage of the currency note from an opening to a storage compartment, a currency note validator for examining and validating currency notes along the pathway and an obstruction operatively associated with the currency note validator, the obstruction being changeable to a first operative state to obstruct passage in and/or out of the storage compartment and changeable to a second operative state to allow passage of the currency note along the pathway into the storage compartment, the method including:

configuring the acceptor to:

receive a currency note through the opening during a receiving phase;

allow the received currency note to be validated by the currency note validator and pass along the pathway to the storage compartment during an accepting phase; and

obstructing passage in and/or out of the storage compartment in a subsequent receiving phase for a subsequent currency note.

Configuring can include reconfiguration.

Any of the features described above in connection with the other aspects of the invention set out herein may be applicable to the third aspect of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a currency note acceptor in accordance with an embodiment of the present invention, the currency note acceptor including a stacker module attached therewith and shown in the process of accepting a currency note from a consumer;

FIG. 2 is a side view of the currency note acceptor of FIG. 1, with select internal components of the currency note acceptor made visible;

FIG. 3 is an exploded rear perspective view of some of the internal components of the stacker module of the currency note acceptor of FIG. 1;

FIG. 4 is an exploded front perspective view of FIG. 3;

FIG. 5A is a sectional view of the internal components of the stacker module of FIG. 3, illustrating an obstruction assembly in an operative state that does not prevent access of a foreign object to a storage compartment of the stacker module;

FIG. 5B is a sectional view of the internal components of the stacker module of FIG. 3 illustrating the obstruction assembly in an operative state that does prevent access of the foreign object to the storage compartment of the stacker module;

FIG. 6A is a sectional view of the internal components of the stacker module with the obstruction assembly in an operative state preventing access of a foreign object to the storage compartment of the stacker module;

FIG. 6B is a sectional view of the internal components of the stacker module with the obstruction assembly in an operative state allowing access of a currency note to the storage compartment of the stacker module;

FIG. 6C is a sectional view of the internal components of the stacker module with a punch plate of the obstruction assembly in an operative state urging the currency note into the storage compartment of the stacker module;

FIG. 6D is a sectional view of the internal components of the stacker module with the obstruction assembly in an operative state preventing access to the currency note by a foreign object after the currency note has been stored in the storage compartment;

FIG. 7 is a rear perspective view of an alternative embodiment of one of the internal components of the stacker module of the currency note acceptor of FIG. 1; and

FIG. 8 is a side schematic view of a change dispenser, pay station, vending machine, electronic gaming machine or other equipment including the currency note acceptor or FIG. 1.

### DETAILED DESCRIPTION OF THE EMBODIMENTS

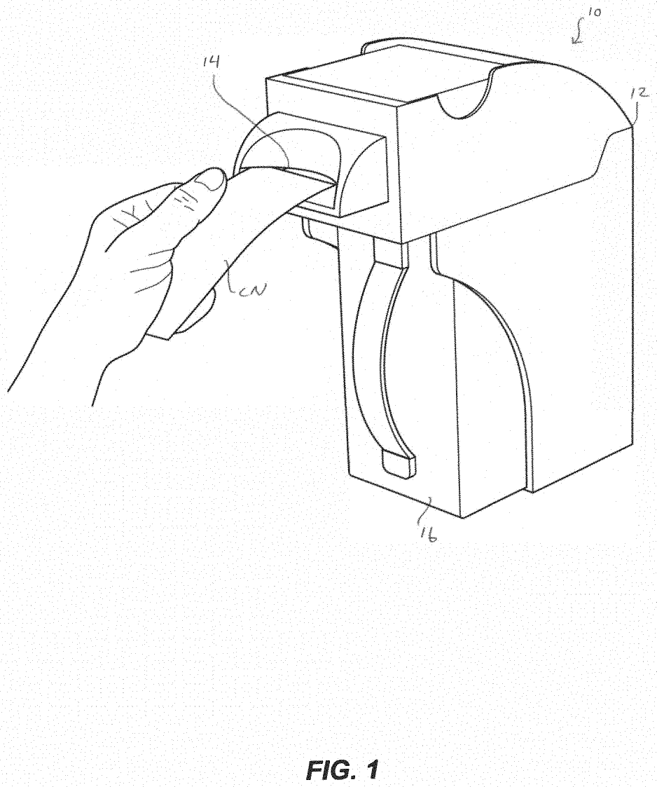

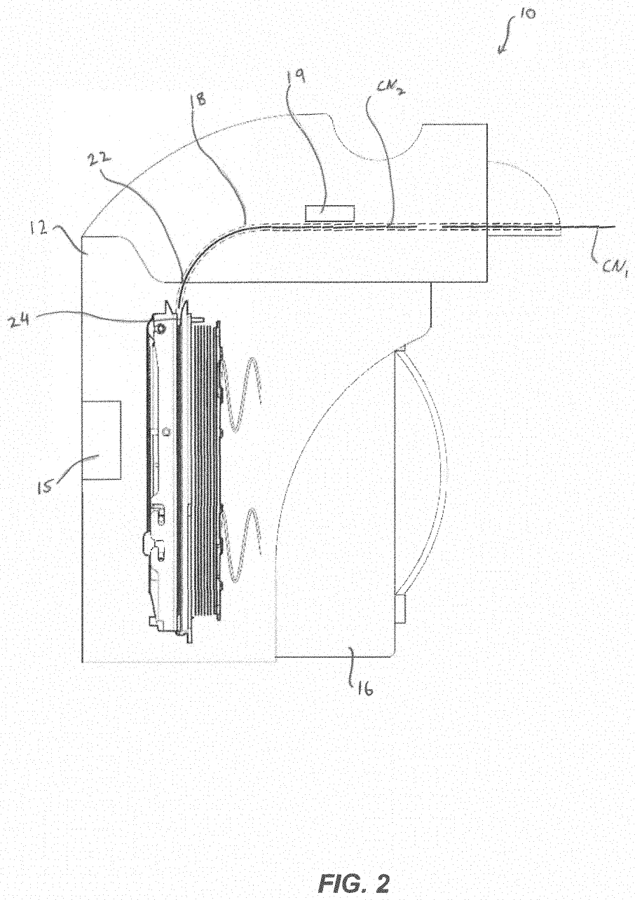

With reference to FIGS. 1 and 2, there is shown a currency note acceptor 10 in accordance with one embodiment of the present invention. Much of currency note acceptor 10 works in the conventional manner and will already be understood to a person skilled in the art. For example, known commercial products of this general type include the GBA GV1 sold under the Global Bill Acceptor brand.

The acceptor 10 includes a housing 12 in which structure is provided defining a currency note path 18, which is communicable with an elongate slot opening 14 configured to receive the currency note CN from a consumer in a receiving phase of operation. Whilst only one path is shown in FIG. 2, it will be understood that housing 12 may include more than one path. For example, paths may extend between opening 14 and other ancillary components that may form part of acceptor 10. Depending on the application, this can include amongst other things ticket/token readers, ticket/token printers, etc. Such ancillary components may be provided as separate modular units that can be attached to housing 12 or be formed as part of housing 12.

The acceptor 10 further includes a conveyor assembly (not shown) configured to move the currency note CN along the path 18, from the opening 14 towards a note receiver, such as stacker module 16, for storage of the currency note. The conveyor assembly is of known type, and can include components such as rollers, belts, etc. The conveyor assembly can also convey the currency note out of acceptor 10, as may be the case if the acceptor is intending to return change or if the currency note has been rejected. The stacker module 16, also known as a cashbox or note cassette, is of known construction and need not be described further. One example of a suitable stacker module is disclosed in U.S. Pat. No. 6,712,352 B2, the contents of which are incorporated herein by reference.

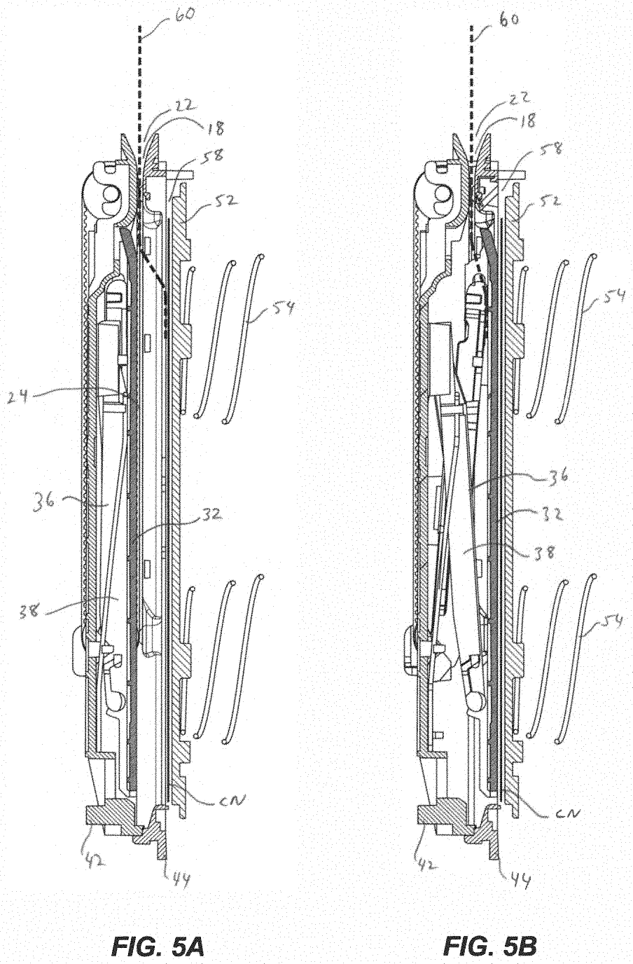

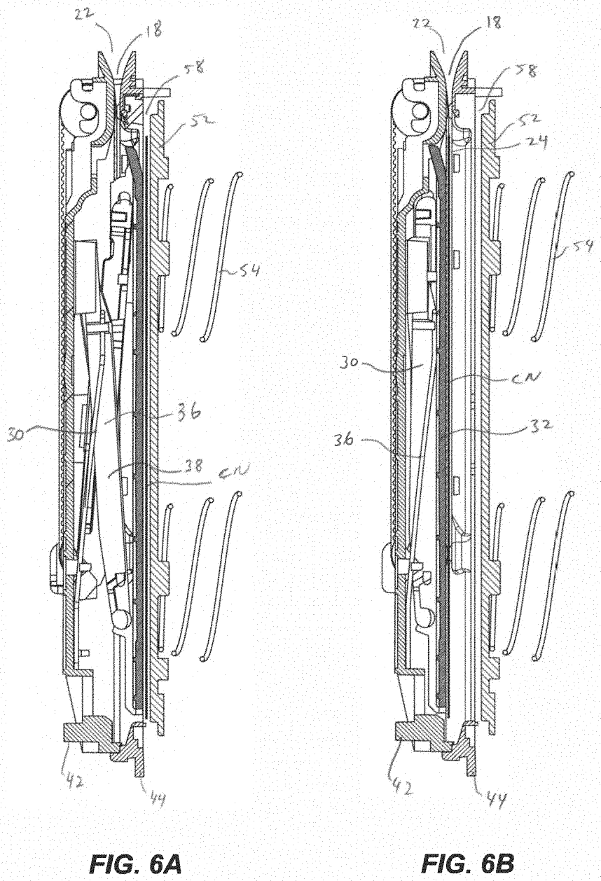

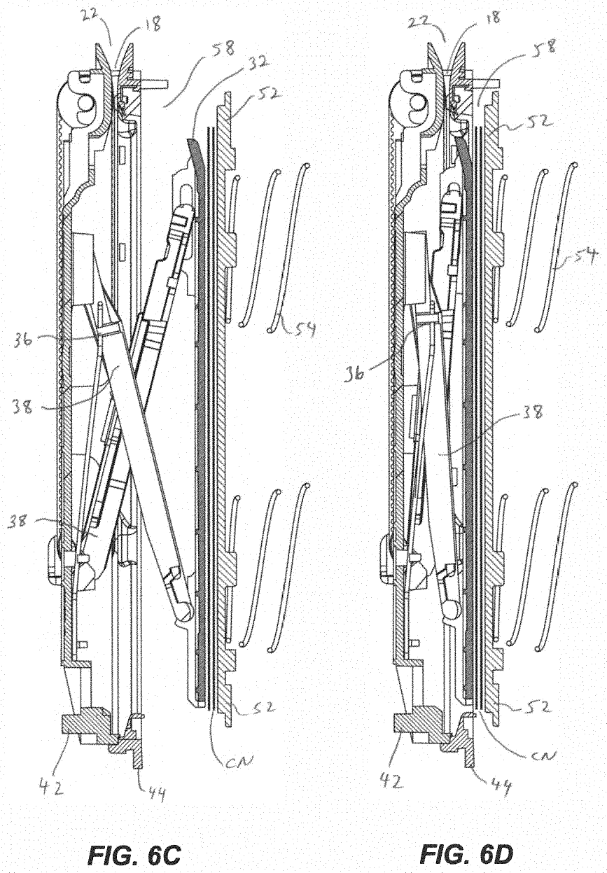

Stacker module 16 includes a holding compartment aperture 22, which provides entry for the currency note CN into a holding compartment 24 (best shown in FIG. 6B) of the stacker module 16. Once a currency note CN is positioned in the holding compartment 24, it is then moved (as will be explained further below) through an entry into a storage compartment 58 (FIGS. 5A-6D) for the storage of currency note CN. Whilst acceptor 10 in this embodiment includes a separate and distinct stacker module that is removable from acceptor 10 and that forms part of housing 12 when attached therewith, in alternative embodiments the housing 12 can be designed to include the storage compartment therein, without the need for a separate removable stacker module. Thus, components described herein forming part of the stacker module may in an alternative embodiment form part of housing 12.

The acceptor 10 also includes a currency note validator 19 disposed adjacent path 18 between opening 14 and stacker module 16 for examining and validating currency notes. Currency note validator will typically be a currency note validator of known configuration and may be an existing commercially available unit. It will be understood that the currency note validator may typically include an array of optical elements adapted to scan and respond to predetermined elements of a currency note when it traverses path 18, thereby obtaining and recording a signature signal for the note, and a controller 15 for responding to the comparison that includes a discriminator facility for comparing each recorded signature signal with reference signatures or with predetermined value ranges for components of the signature. Housing 12 also includes control electronics (not shown) mounted therein for controlling and powering various electronic components of acceptor 10.

The primary modification to the currency note acceptor 10 relates to an obstruction assembly 30 as will be explained below.

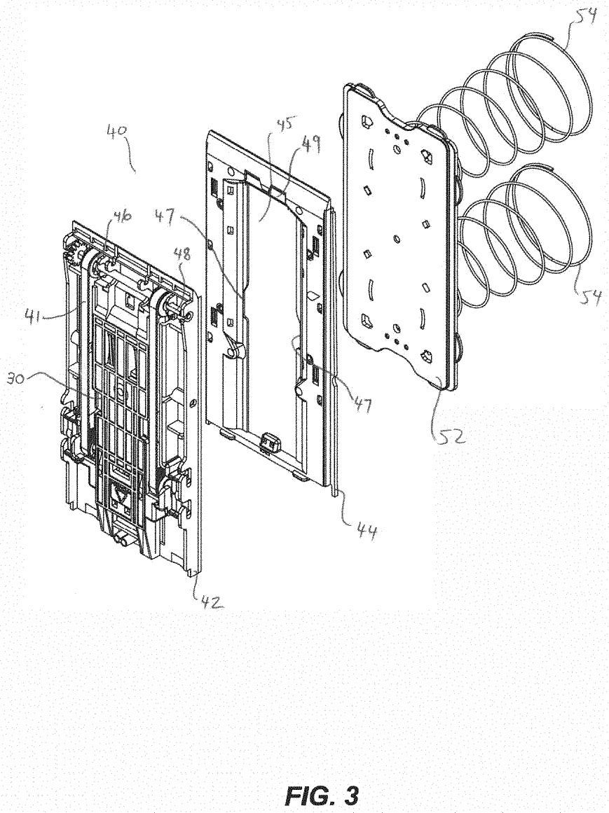

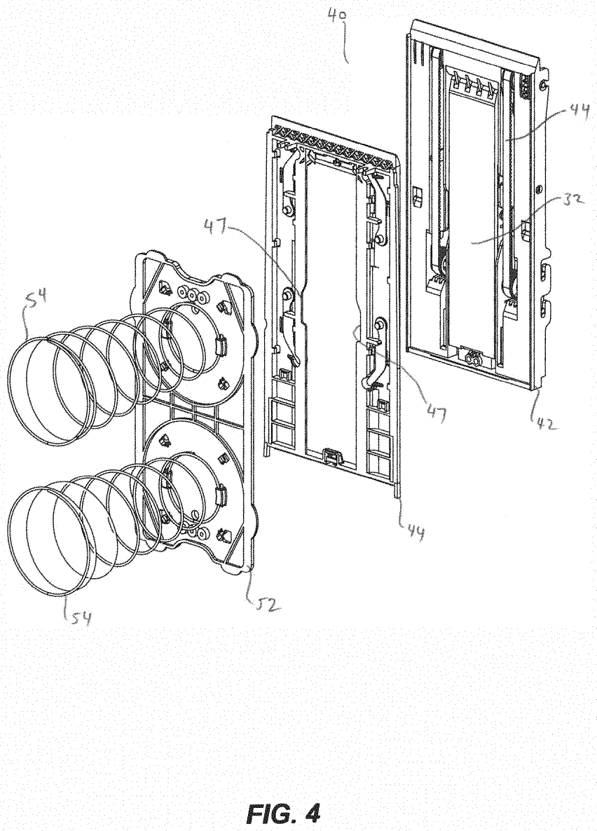

With reference to FIGS. 3 and 4, an exploded view is provided of some of the internal components of the stacker module 16. Stacker module 16 includes a currency note guide subassembly 40, which comprises a first portion 42 and a second portion 44 in between which exists a space defining the holding compartment 24. First portion 42 is a substantially planar, rectangular frame-like support structure that affords mounting to various components of acceptor 10, including some of the components of the conveyor assembly and obstruction assembly 30. For example, as best shown in FIG. 3, a conventional belt and pulley drive mechanism including belts 41, pulleys 46 and driven shaft 48 mounted to first portion 42, the drive mechanism forming part of the conveyor assembly of acceptor 10. This particular part of the conveyor assembly leads the currency note CN from holding compartment aperture 22 to holding compartment 24, so as the currency note can be pushed into storage compartment 58 of the stacker module 16.

The currency note path 18 in the present embodiment will be understood to extend from opening 14 to the terminus of the note path 18 being storage compartment 58.

As best shown in FIG. 4, mounted to first portion 42 is a punch plate 32, which is configured to move between a number of possible positions. The punch plate 32 has at least two fundamental roles. One role is to push a currency note disposed in the holding compartment through an entry into the storage compartment 58. The other role is to perform an obstructing action, whereby the punch plate obstructs access of a foreign object to the stored currency note. This will be discussed in greater detail below. The punch plate 32 is elongate and of substantially planar and rectangular shape as is known in the art.

It will be appreciated that punch plate 32 is movably mounted to first portion 42 by a scissor arm mechanism 36 (see FIGS. 5A-6D). The scissor arm mechanism 36 comprises a pair of scissor arm members 38. One end of each scissor arm member 38 is pivotally mounted to the first portion 42 and the other end of each scissor arm member 38 is pivotally mounted to the punch plate 32. The pivotal mounting connections between the scissor arm members 38 and the punch plate 32 and the scissor arm members 38 and the first portion 42 can be of any known pivotal mounting arrangement. The control electronics, specifically controller 15, is programmed to actuate and move the scissor arm members 38, and thereby move the punch plate 32, between various possible positions depending on what stage of the currency note storage process the acceptor is in. For example, during normal operation, the controller sends a signal to scissor arm actuators (not shown), which comprises actuating mechanisms as known in the art, to drive the scissor arm mechanism 36 in order to move punch plate 32 between its various operating positions as will be described in greater detail below.

Second portion 44 is a substantially rectangular structure that acts as a dividing wall between holding compartment 24 and the storage compartment 58 of stacker module 16. Second portion 44 includes an entry into the storage compartment in the form of storage entry aperture 45 configured to permit entry of currency note CN into the storage compartment 58 of the stacker module 16. Aperture 45 is of a substantially rectangular shape having a height dimension and a width dimension that permits the currency note to pass therethrough when pushed by the punch plate 32. In other words, the height dimension of the aperture can be set to be slightly greater than, slightly less than or approximately equal to the height dimension of conventional currency notes expected to be encountered by the acceptor 10. Similarly, the width dimension of the aperture can be set to be slightly greater than, slightly less than, or approximately equal to the width dimension of conventional currency notes expected to be encountered by the acceptor 10. In the depicted embodiment, the dimensions of the aperture are such that in an exemplary obstructing position of the punch plate 32, the punch plate 32 can be disposed substantially flush with the surround about the aperture 45, thereby substantially blocking access to the storage compartment for any foreign objects.

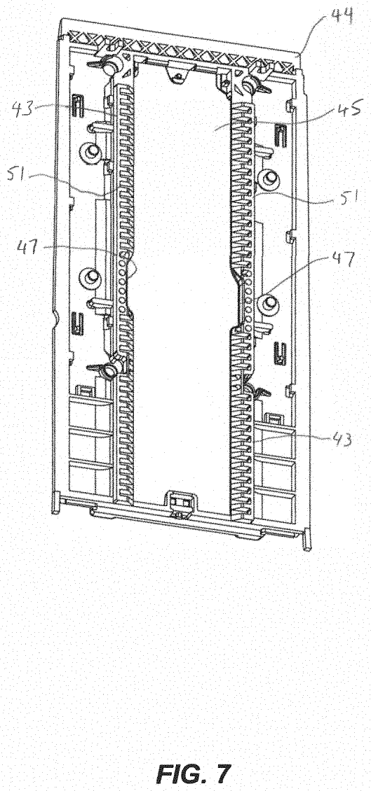

Second portion 44 also includes a pair of transversely aligned recessed portions 47, which extend away from longitudinal sides of the periphery of aperture 45. Recessed portions 47 provide clearance for the scissor arm members 38 when the punch plate 32 is moved to push the currency note CN into the storage compartment 58. As best shown in FIG. 7, in an alternative embodiment, second portion 44 also includes an upstand 43 about the longitudinal sides of the periphery of aperture 45 on the storage compartment side of second portion 44. Upstand 43 is configured to provide an abutment surface 51 for currency notes stored in the storage compartment 58. The stored currency notes are therefore firmly held between the upstand 43 and platen 52, thereby ensuring that the stored currency notes do not impede the aperture 45 or get stuck at least partially stuck in holding compartment 24 after being pushed by the punch plate 32.

A security device 49 is mounted at an upper end of the aperture 45 as shown in FIGS. 3 and 4. Security device 49 includes at least one currency note cutting-edge and at least one string cutting surface. Security device 49 can be used to cut a currency note or any components attached thereto when a fraudulent withdrawal of the bill is attempted. This may act as an additional deterrent to mitigate against fraudulent withdrawal of the currency note. The reader is directed to US patent 9,218,702, hereby incorporated by reference, which provides additional detail about one example of such a security device.

The stacker module 16 further includes a platen 52 and a pair of springs 54. These components are located within the storage compartment 58 of stacker module 16. The platen 52 is biased toward second portion 44 by the springs 54, one end thereof attached on a rear side of the platen 52 and the other end attached to a wall of the stacker module 16. When the currency note CN enters the storage compartment of stacker module 16, it is placed against platen 52 or against the most recently stacked currency note CN already on platen 52. Thus, platen 52 is used for stacking a plurality of currency notes CN. It will be appreciated that the storage compartment is of the stacking type. However, the stacker module may instead be a conventional note receiver that does not require any stacking to take place in the storage compartment.

Reference is now made to FIGS. 5A and 5B which illustrate two different operative states of obstruction assembly 30. These figures illustrate first portion 42, second portion 44, and platen 52 in their assembled operative positions. FIG. 5A illustrates first portion 42, second portion 44, and platen 52 in their assembled operative positions when the obstruction assembly 30 is in a second operative state. In this second operative state, the punch plate 32 is adjacent holding compartment 24, thereby providing a clear unobstructed path for a currency note to enter the storage compartment 58. However, this position, provides a clear unobstructed path for a foreign object 60 (depicted as a string) to move along the path 18, through aperture 45, and to a stored currency note CN in storage compartment 58, whereby the currency note CN can potentially be ‘fished’. In other words, assuming the currency note has been appropriately rigged to be hooked by string 60, the string 60 can pass through the path 18 unobstructed, hook the currency note CN, and pull the currency note CN out of the storage compartment 58 through aperture 45, back along path 18 and out of acceptor 10 through opening 14.

FIG. 5B illustrates first portion 42, second portion 44, and platen 52 in their assembled operative positions when the obstruction assembly 30 is in a first operative state according to an embodiment of the invention. In this first operative state, the punch plate 32 is in an obstructing position, substantially blocking aperture 45 and preventing string 60 from moving through aperture 45 and reaching currency note CN. As mentioned earlier, the punch plate 32 can be disposed substantially flush with the surround about the aperture 45 in the first operative state of the obstruction assembly 30. However, this need not be the case. For example, the punch plate 32 in the first operative state can be positioned in holding compartment 24, thereby still providing an obstructed path for string 60. In another alternative, the punch plate 32 can be positioned between holding compartment 24 and aperture 45, and in some cases beyond aperture 45 (e.g. within the storage compartment 58) so long as punch plate 32 obstructs the passage of string 60 to a rigged currency note. Scissor arm members 38 can also play a role in obstructing string 60 from reaching currency note CN. The nature of the scissor arm mechanism provides added difficulty for a consumer attempting to direct string 60 through path 18 and to currency note CN. The presence of the scissor arm members in path 18 in the first operative state of the obstruction assembly 30 can cause string 60 to become entangled, or at least provide an additional hindrance to string 60 reaching currency note CN.

Reference is now made to FIGS. 6A-6D, which illustrate the different operative states of the punch plate 32, and hence obstruction assembly 30, during the process of storing a currency note, which includes receiving the currency note in the currency note acceptor 10 in a receiving phase, and the currency note going through an accepting phase, wherein the currency note is validated and then ultimately stored in the storage compartment 58, and how the obstruction assembly 30 prevents a consumer from fraudulently withdrawing the currency note CN thereafter.

FIG. 6A shows punch plate 32 positioned in the first operative state, or what can be described as a home position of punch plate 32 in acceptor 10, in which the punch plate 32 is disposed substantially flush with aperture 45, thereby preventing a foreign object from retrieving a currency note CN. The acceptor 10 is in the receiving phase here. When a currency note is received through opening 14 by a consumer, the controller 15 sends a signal to the conveyor assembly to move the currency note past the currency note validator 15 into an escrow position (see for example CN₂ in FIG. 2) where the currency note awaits validation.

When currency note CN has been validated, the controller sends a signal to the scissor arm actuators to retract scissor arm members 38, causing the scissor arm members 38 to pivot away from holding compartment 24, thereby moving punch plate 32 into its unobstructed position adjacent holding compartment 24. Thus, obstruction assembly 30 is moved to the second operative state, wherein holding compartment 24 is not obstructed. The controller sends a signal to the conveyor assembly to move the currency note CN beyond the escrow position and convey the currency note CN through holding compartment aperture 22 to the holding compartment 24 and adjacent aperture 45 as shown in FIG. 6B.

The currency note CN must now be urged into the storage compartment 58 of stacker module 16. The controller sends a signal to the scissor arm actuators to extend scissor arm members 38, causing the scissor arm members 38 to pivot towards holding compartment 24, thereby moving punch plate 32 into its extended punch position. The currency note CN is pushed through aperture 45 and into the storage compartment 58. The full extent of the extended punch position of punch plate 32 can terminate beyond aperture 45 (as shown in FIG. 6C) and into storage compartment 58. This can create a pushing force on platen 52, and hence compression of spring 54. Alternatively, the pushing position of punch plate 32 can terminate in a position that creates little direct pushing force on platen 52. Currency note CN has thus been moved into the storage compartment 58 and onto a stack of any earlier stored currency notes. The currency note CN can be punched more than once, e.g. twice, to ensure that currency note CN passes through aperture 45 and into the storage compartment 58. This enhances the likelihood that the currency note CN is properly received in the storage compartment 58. This is further improved in embodiments that include upstand 43 as previously described. A signal is now sent to the controller 15 indicating that the currency note has been stored in the storage compartment 58. The consumer at this stage is now provided appropriate credit for the transaction. This point may be considered in this embodiment as the end of the accepting phase.

The controller 15 now sends a signal to the scissor arm actuators to retract scissor arm members 38 so that the scissor arm mechanism 36 moves the punch plate 32 from the extended punch position back to the obstructing position, i.e. the obstruction assembly is to again operate in the first operative state. This again causes the scissor arm members 38 to pivot away from holding compartment 24, moving punch plate 32 into the obstructing position flush with aperture 45. This completes one cycle of the currency note storage method, with acceptor 10 returned to the receiving phase, ready to receive another currency note, but most importantly, acceptor 10 is operating in the first operative state, whereby the path to the currency note is obstructed to prevent fraudulent withdrawal of the currency note from the acceptor 10.

In alternative embodiments, after the currency note has been punched into the storage compartment 58, the controller may be programmed to return the obstruction assembly to the second operative state for a predetermined, usually small period of time. The controller can then send a further signal to the scissor arm actuators to move scissor arm members 38 so that the punch plate 32 can reassume the first operative position, i.e. where the punch plate is disposed substantially flush with aperture 45 (FIG. 6D).

The above describes a full cycle of the movement of the punch plate 32, which can for example be actuated by a stepper motor. Upon completion of this full cycle, if a consumer attempts to use a foreign object to retrieve the most recently stored currency note CN, the foreign object will encounter the push plate 32 and scissor arms 38, thereby obstructing the foreign object's path to the recently stored currency note.

In the example described above, the punch plate 32 remains in the obstructing position, obstructing the path of any foreign objects to the storage compartment, until another currency note is validated by the currency note validator. However, this does not necessarily need to be the case. The controller may instead be programmed to move the obstruction assembly 30 from the first operative position to the second operative position after a predetermined amount of time has elapsed since the most recent currency note was stored in the storage compartment. The predetermined amount of time can coincide with an expected amount of time after storage of the most recent currency note in which the consumer who provided the last currency note is considered unlikely to return and attempt to withdraw the currency note CN. In another embodiment, the acceptor 10 may include sensors, such as proximity sensors, that move the obstruction assembly from the second operative state to the first operative state when a person or object is detected nearby to the acceptor. This ensures that the acceptor is operating in the first operative state, i.e. obstructing access to the storage compartment of the acceptor, whenever a person is detected to be in the vicinity of acceptor 10, and then only operating in the second operative position once a received currency note has been validated.

Whilst the obstruction assembly/obstructer mentioned in the above embodiment describes a movable obstruction, the obstruction assembly/obstructer may be of another form. The obstructer/obstruction assembly is generally changeable between at least two operative states. The obstructer may in an alternative embodiment not be the punch plate or associated scissor arms, but instead be a mechanical gate, pneumatic bladders that are inflatable to obstruct the pathway and/or entry into the storage compartment. A person skilled in the art will appreciate other suitable configurations for an obstructer in view of the teachings herein.

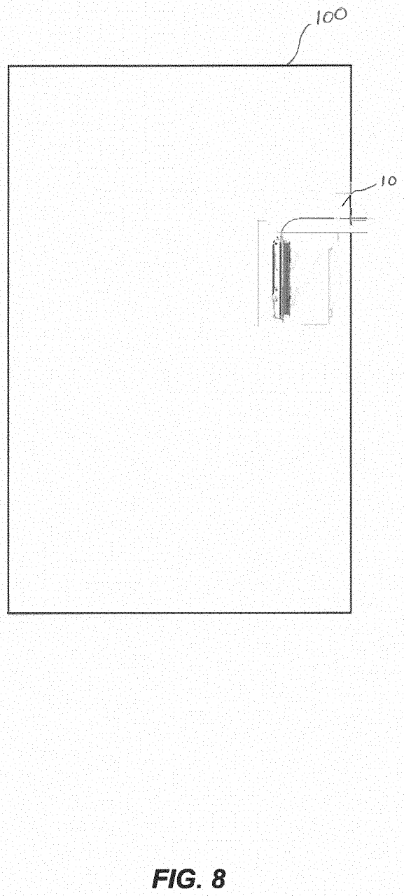

FIG. 8 illustrates a change dispenser, pay station, vending machine, electronic gaming machine or other equipment 100 including the acceptor 10.

It will also be appreciated that in some circumstances, existing bill acceptors may be configured or reconfigured/re-programmed to operate according to a storage method as described above, whereby the bill acceptors operate in the first operative state during a receiving phase, thereby obstructing passage in and/or out of the storage compartment in the receiving phase.

It will be understood that the invention disclosed and defined in this specification extends to all alternative combinations of two or more of the individual features mentioned or evident from the text or drawings. All of these different combinations constitute various alternative aspects of the invention.

1. A currency note acceptor for accepting currency notes, including:
a housing defining a pathway for passage of an inserted currency note from an opening to a storage compartment;
a currency note validator for examining and validating currency notes along the pathway;
an obstruction operatively associated with the currency note validator, the obstruction being changeable between a first operative state to obstruct entry in and/or out of the storage compartment and a second operative state to allow passage of the currency note along the pathway into the storage compartment;
wherein the acceptor is operable to:
receive a currency note during a receiving phase;
change the obstruction during an accepting phase such that it is in the second operative state following validation of the currency note to allow stowage of the note in the storage compartment; and
subsequently change the obstruction such that it is in the first operative state during a subsequent receiving phase for a subsequent currency note.

2. The currency note acceptor of claim 1, wherein the changeable obstruction comprises a movable obstruction.

3. The currency note acceptor of claim 2, wherein the movable obstruction has an associated driver and is driven between the first and second operative states.

4. The currency note acceptor of claim 3, wherein between the entry of the storage compartment and the storage compartment itself is provided a storage entry aperture which provides access for the note into the storage compartment.

5. The currency note acceptor of claim 4, wherein the obstruction is disposed at or within the storage entry aperture in the first operative state.

6. The currency note acceptor of claim 5, wherein the obstruction resides substantially flush with the storage entry aperture in the first operative state until a subsequent note is validated, triggering a change of the obstruction to the second operative state.

7. The currency note acceptor of claim 6, wherein the movable obstruction takes the form of a punch or push plate, which has a dual function of punching or pushing the note from the pathway into the storage compartment.

8. The currency note acceptor of claim 7, wherein the note is punched or pushed by the punch or push plate on more than one occasion to ensure that the note is received in the storage compartment.

9. The currency note converter of claim 7, wherein the first operative state includes a plurality of positions of the punch or push plate.

10. The currency note acceptor of claim 4, further including an upstand extending from at least a portion of the periphery of the storage entry aperture towards the storage compartment, wherein the upstand includes an abutment surface configured to abut against the note.

11. The currency note acceptor of claim 1, wherein the currency note acceptor includes a controller associated with the currency note validator and the obstruction.

12. The currency note acceptor of claim 11, wherein the obstruction adopts the first operative state upon the controller sending a first indication that a currency note has been urged into the storage compartment, and the obstruction adopts the second operative state upon the controller sending a second indication that a currency note has been validated.

13. The currency note acceptor of claim 12, wherein the controller is configured to receive a signal from the currency note validator as to whether a currency note has been validated, wherein if the currency note has been validated, the controller will send the second indication.

14. The currency note acceptor of claim 13, wherein when the controller has received a further signal that the currency note has entered the storage compartment, the controller sends the first indication, causing the obstruction to adopt the first operative state in which entry into the storage compartment and/or the storage compartment itself is obstructed.

15. The currency note acceptor of claim 7, wherein the obstruction is part of an obstruction assembly, the obstruction assembly including a movable scissor arm mechanism associated with the punch or push plate, the scissor arm mechanism including one or more scissor arm members, wherein when the obstruction assembly is in the first operative state, the one or more scissor arm members obstruct the pathway.

16. A change dispenser, pay stations, vending machine, electronic gaming machine or other equipment including the currency note acceptor as claimed in claim 1.

17. A method for storing currency notes in a currency note acceptor which includes a pathway for passage of the currency note from an opening to a storage compartment and a currency note validator for examining and validating currency notes along the pathway, the method including:
receiving a currency note through the opening during a receiving phase;
allowing the inserted currency note which has been validated by the currency note validator to pass along the pathway to the storage compartment during an accepting phase; and
obstructing passage in and/or out of the storage compartment during a subsequent receiving phase for a subsequent currency note.

18. The method of claim 17, further including:
receiving the subsequent currency note during the subsequent receiving phase whilst obstructing passage in and/or out of the storage compartment.

19. A method for configuring a currency note acceptor which includes a pathway for passage of the currency note from an opening to a storage compartment, a currency note validator for examining and validating currency notes along the pathway and an obstruction operatively associated with the currency note validator, the obstruction being changeable to a first operative state to obstruct passage in and/or out of the storage compartment and changeable to a second operative state to allow passage of the currency note along the pathway into the storage compartment, the method including:
configuring the acceptor to:
receive a currency note through the opening during a receiving phase;
allow the received currency note to be validated by the currency note validator and pass along the pathway to the storage compartment during an accepting phase; and
obstructing passage in and/or out of the storage compartment in a subsequent receiving phase for a subsequent currency note.

20. The method of claim 19, wherein configuring the acceptor includes reconfiguring.
